(19) United States
(12) Patent Application Publication
(10) Pub. No.: US 2025/0160321 A1
(43) Pub. Date: May 22, 2025

(54) A STABLE AGROCHEMICAL COMPOSITION

(71) Applicants: UPL Corporation Limited, Port Louis (MU); UPL Europe LTD, Warrington Cheshire (GB)

(72) Inventors: Charles Flood, Worcestershire (GB); Nicholas Bourne, Worcestershire (GB)

(21) Appl. No.: 18/839,486

(22) PCT Filed: Feb. 23, 2023
(86) PCT No.: PCT/GB2023/050377

§ 371 Date: Aug. 19, 2024

(30) Foreign Application Priority Data
Feb. 21, 2022 (GB) 2202303.0

(51) Int. Cl. A01N 25/04; A01N 25/22; A01N 47/34; A01N 53/00; A01P 7/04

(52) U.S. Cl. CPC A01N 25/04; A01N 25/22; A01N 47/34; A01N 53/00; A01P 7/04

(57) ABSTRACT

The present disclosure relates to a stable suspoemulsion composition comprising: a suspension phase comprising a benzoylphenylurea insecticide: an emulsion phase comprising a pyrethroid insecticide; and a crystallization controlling system comprising at least two surfactants. The present disclosure also relates to a process for preparation of the suspoemulsion composition, a method of application and use of the stable suspoemulsion composition for controlling growth of insects/pests in plants.

### FIELD OF THE DISCLOSURE

The present disclosure relates to a stable agrochemical composition comprising a pyrethroid insecticide and a benzoylphenylurea insecticide. More particularly, the present disclosure relates to a stable suspoemulsion (SE) formulation of a pyrethroid insecticide and a benzoylphenylurea insecticide.

### BACKGROUND OF THE DISCLOSURE

In recent years, there has been a desire to increase the efficacy, broaden the spectrum, and delay resistance to insecticides by combining application of two or more products. In the agricultural practices, effective pest control involves combination of two or more insecticides with different modes of action. The insecticidal treatment is said to be effective if it is planned in a way that gives immediate action on the pests (known in the art as “knock-down action”) as well as provides long-term action (known also as “residual action”). Effective knock-down insecticides include pyrethroids, organic phosphoric acid esters, neonicotinoids and phenyl pyrazoles. Effective long-term insecticides include insect growth regulators (IGR) of various types, e.g., chitin synthesis inhibitors. Current methods for achieving the desired effect include repeated treatments over time with insecticides which have an effective knock-down action.

Benzoylphenylureas are chemical derivatives of N-benzoyl-N′-phenylurea (benzoylurea). They are best known for their use as insecticides. They act as insect growth regulators (IGRs) by inhibiting synthesis of chitin in the insect's body, hence also known as chitin synthesis inhibitors. A first insecticide of this class to be used commercially was diflubenzuron. It is used for the control of chewing insects and coleopteran pests (i.e., beetles and weevils) in fruit, cotton, soybeans, and vegetable crops. Other insecticides include chlorfluazuron, flufenoxuron, hexaflumuron and triflumuron. Benzoylphenylureas, such as lufenuron and triflumuron, due to their relative non-toxic nature to vertebrates, are used in veterinary medicine and in the home against pests such as fleas, ticks, and cockroaches. Diflubenzuron is an insecticide of the benzoylphenylurea class. The mechanism of action of diflubenzuron involves inhibiting the production of chitin which is used by an insect to build its exoskeleton. It triggers insect larvae to molt early without a properly formed exoskeleton, resulting in the death of the larvae. Diflubenzuron is a direct-acting insecticide normally applied directly to plants or water.

Pyrethroid insecticides have been used for many years to control agricultural and common household pests. Pyrethroids are generally used as isomer mixtures. They have been used for a long time as insecticides, in particular against common houseflies, cockroaches or black beetles and other household pests like vermin, moths, corn weevils, mosquitoes, garden and greenhouse parasites, and hay worms in viticulture and boll-weevils. Lambda-cyhalothrin is a commonly used pyrethroid insecticide consisting of enantiomers (S)-a-cyano-3-phenoxybenzyl (Z)-(1R,3R)-3-(2-chloro-3,3,3-trifluoroprop-1-enyl)-2,2-dimethylcyclopropanecarboxylate and (R)-a-cyano-3-phenoxybenzyl (Z)-(1S,3S)-3-(2-chloro-3,3,3-trifluoroprop-1-enyl)-2,2-dimethylcyclopropanecarboxylate in a racemic proportion. Lambda-cyhalothrin is commonly formulated in solid as well as liquid type of formulations. However, not all formulations are successful in terms of retaining desired efficacy due to their low melting point that pose processing challenges, especially in solid formulations. Also, greater care is required to tackle the isomer instability related to lambda-cyhalothrin especially in liquid formulations.

Furthermore, combining benzoylphenylurea insecticides and pyrethroid insecticides are known in the prior art. Patent application CN1176589C discloses combination of benzoyl urea and pyrethroid reasonably with a purpose of overcoming pest resistance to insecticide, enlarge insecticidal spectrum and to improve the effectiveness of the formulation. According to this reference, benzoyl urea and pyrethroid are combined to form miscible oil, wetting powder, oil-suspending agent, microemulsion, water-dispersible granules or microcapsule formulations. However, it does not specifically disclose suspoemulsion formulation of diflubenzuron and lambda-cyhalothrin and its process of preparation.

Patent application CN105028461A discloses an insecticidal composition containing diflubenzuron and deltamethrin in which the active ingredients may be combined to form wetting powder, water dispersible granules, suspending agent, aqueous emulsion, miscible oil or seed coat agent. This disclosure specifically explains various types of formulations of diflubenzuron and deltamethrin and their efficacy in a ratio of 40:1-1:20, respectively. However, it does not specifically disclose suspoemulsion of diflubenzuron and lambda-cyhalothrin and its process of preparation.

While these prior arts generally disclose various formulations of a combination of pesticidal active ingredients such as a water-dispersible granule, suspension concentrate wettable powder, emulsifiable concentrate, oil dispersion, suspension etc., they do not provide or teach a specific formulation type comprising lambda-cyhalothrin and diflubenzuron in a form of a biphasic system such as a suspoemulsion.

It is known in the art that preparing a liquid composition of pyrethroid insecticides (especially, lambda-cyhalothrin) in combination with other insecticides have always been challenging due to inherent physico-chemical profile of the compound that includes low melting point, isomer instability and pH sensitivity. Also, it has been noticed that pyrethroid insecticides sometimes interfere with the stability of the other active ingredient. Thus, commonly practised agrochemical compositions combining pyrethroid insecticide with another insecticide in the form of a suspension concentrate, an emulsifiable concentrate, or an oil-dispersion may not be that feasible. Similarly, while combining a benzoylphenylurea insecticide, especially diflubenzuron and a pyrethroid insecticide, especially lambda-cyhalothrin in a single formulation, managing the physico-chemical profile of both the active ingredients is challenging. Isomer stability as well as the pH sensitivity associated with lambda-cyhalothrin require to be taken care. Moreover, it has been seen that diflubenzuron remains quite stable in a suspension concentrate (SC) formulation but when it is combined with other actives in a biphasic type of formulation, such as a suspoemulsion, it suffers crystal growth problems. Therefore, it would be desirable to provide a stable composition comprising diflubenzuron and lambda-cyhalothrin under ambient storage conditions (i.e., −5° C. to 50° C.) as well as after dilution.

### OBJECTIVES OF THE DISCLOSURE

It is a primary objective of the present disclosure to provide an agrochemical composition of a benzoylphenylurea insecticide and a pyrethroid insecticide.

It is yet another objective of the present disclosure to provide a stable suspoemulsion composition of a benzoylphenylurea insecticide and a pyrethroid insecticide.

It is another objective of the present disclosure to provide a suspoemulsion composition of a benzoylphenylurea insecticide and a pyrethroid insecticide with improved shelf life.

It is another objective of the present disclosure to provide a suspoemulsion composition of a benzoylphenylurea insecticide and a pyrethroid insecticide, which prevents crystal growth in the suspoemulsion composition upon storage.

It is yet another objective of the present disclosure to provide a process for preparation of a suspoemulsion composition of a benzoylphenylurea insecticide and a pyrethroid insecticide.

It is yet another objective of the present disclosure to provide a method for controlling pests using a suspoemulsion composition of a benzoylphenylurea insecticide and a pyrethroid insecticide.

### SUMMARY OF THE DISCLOSURE

In one aspect of the present disclosure, the disclosure provides a stable suspoemulsion composition comprising:
a suspension phase comprising a benzoylphenylurea insecticide;
an emulsion phase comprising a pyrethroid insecticide; and
a crystallization controlling system comprising at least two surfactants.

In another aspect of the present disclosure, the disclosure provides a stable suspoemulsion composition comprising:
a suspension phase comprising a benzoylphenylurea insecticide;
an emulsion phase comprising a pyrethroid insecticide; and
a crystallization controlling system comprising a low hydrophile-lipophile balance (HLB) block copolymer surfactant and a high HLB block copolymer surfactant in a weight ratio ranging from about 0.5:1 to about 0.5:5.

In yet another aspect of the present disclosure, the disclosure provides a process for preparation of the stable suspoemulsion composition comprising:
a suspension phase comprising a benzoylphenylurea insecticide;
an emulsion phase comprising a pyrethroid insecticide; and
a crystallization controlling system comprising at least two surfactants.

In yet another aspect of the present disclosure, the disclosure provides a method for controlling pests, said method comprising applying to the pests or to their locus thereof, a pesticidally effective amount of the stable suspoemulsion composition comprising:
a suspension phase comprising a benzoylphenylurea insecticide;
an emulsion phase comprising a pyrethroid insecticide; and
a crystallization controlling system comprising at least two surfactants in a weight ratio ranging from about 0.5:1 to about 0.5:5.

Additional features and advantages of the present disclosure will be apparent from the detailed description that follows, which illustrates by way of example, the most preferred features of the present disclosure which are not to be construed as limiting the scope of the disclosure described herein.

### BRIEF DESCRIPTION OF THE FIGURES

FIGS. 1 to 4 contain images of the composition produced according to example 1 after storage under differing conditions.

### DETAILED DESCRIPTION OF THE DISCLOSURE

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. Hence, the following descriptions are intended to illustrate some particular embodiments of the disclosure, and not to exhaustively specify all permutations, combinations and variations thereof.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the disclosure, suitable methods and materials are described herein.

It must be noted that, as used in this specification, the singular forms “a,” “an” and “the” include plural referents unless the content clearly dictates otherwise. The terms first, second etc., as used herein are not meant to denote any particular ordering, but simply for convenience to denote a plurality of, for example, layers. The terms “preferred” and “preferably” refer to embodiments of the disclosure that may afford certain benefits, under certain circumstances.

As used herein, the terms “comprising” “including,” “having,” “containing,” “involving,” and the like are to be understood to be open-ended, i.e., to mean including but not limited to.

As used herein, the term “about” or “approximately” is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

While the disclosure has been described with reference to an exemplary embodiment, it will be understood by those skilled in the art that various changes may be made, and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure is not limited to the particular embodiment disclosed as the best mode contemplated for carrying out this disclosure, but that the disclosure will include all embodiments falling within the scope of the appended claims.

As used herein, the expression of various quantities in terms of “%” or “% w/v” or “% w/w” means the percentage by weight of the total solution or composition unless otherwise specified.

As used herein, the term “agrochemical” used herein is understood to denote an agricultural chemical such as pesticides, fungicides, insecticides, acaricides, herbicides, nematicides, plant growth regulators and can be used interchangeably.

As used herein, the term “agrochemically acceptable salt” means a salt which is acceptable for use in agrochemical or horticultural use. The salts referred to herein are agrochemically acceptable salts.

As used herein, the term “insecticide” denotes a compound which controls the growth of insects/pests.

As used herein, the term “insecticidal” refers to the ability of a substance to control the growth of insects/pests.

As used herein, the term “insecticidally effective amount” indicates the quantity of such a compound or combination of such compounds which is capable of controlling the growth of insects/pests. The terms “effective amount” or “agriculturally acceptable effective amount”, refer to an amount of an active ingredient, such as in the disclosed composition(s), which has an adverse effect on insects, treats or prevents diseases in a plant, and is not significantly toxic to the plant being treated. The adverse effect can include killing of the insects/pests (insecticidal), preventing growth of the insects/pests, blocking of biosynthetic pathway(s), or a combination thereof.

As used herein, the term “control” or “disease control” refers to the treatment and/or prevention of a disease. Controlling effects include any and all deviations from the natural development of the disease, for example: killing of the insecticidal agent, retardation of disease development, and decrease in amount or degree of the disease.

As used herein, the term “plant(s)” or “crop(s)” refers to all of the physical parts of a plant, including for example, seeds, seedlings, saplings, roots, tubers, stems, stalks, foliage, and fruits. This term also encompasses plant crops such as fruits. The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

As used herein, the term “locus” refers to the vicinity, area, or place in which the plants are growing, where plant propagation materials of the plants are sown, and/or where the plant propagation materials of the plants will be placed into the soil.

As used herein, the term “plant propagation material” is understood to refer to all of the generative parts of a plant, such as seeds, vegetative material such as cuttings or tubers, roots, fruits, tubers, bulbs, rhizomes, and other parts of plants, germinated plants, and/or young plants which are to be transplanted after germination or after emergence from the soil. These young plants may be protected prior to transplantation by a total or partial immersion treatment/system.

As used herein, the term “seed” embraces seeds and plant propagules of all kinds including but not limited to true seeds, seed pieces, suckers, corms, bulbs, fruit, tubers, grains, cuttings, cut shoots and the like. In a preferred embodiment a seed is a true seed.

As used herein, the term “increased yield” of an agricultural plant means that the yield of a product of the respective plant is increased by a measurable amount over the yield of the same product of the plant produced under the same conditions, but without the application of the compositions described herein. According to the present disclosure, it is preferred that the crop yield be increased by at least 0.5%, preferably at least 2%, more preferably at least 5%, upon application of the combinations and compositions described herein. The composition also increases the vigour/yield of the plant.

As used herein, the term ‘pre-emergence’ refers to the time point before plants emerge from the ground.

As used herein, the term ‘post-emergence’ refers to the time point after plants emerge from the ground.

As used herein, the term “g a.i./L” as used herein denotes the concentration of the respective active ingredient in “grams” present “per litre” of the composition.

As used herein, the term “g a.i./h” as used herein denotes the concentration of the respective active ingredient in “grams” applied “per hectare” of the crop field.

A suspoemulsion (SE) formulation is a biphasic system formed by combination of an emulsifiable concentrate (EC) and a suspension concentrate (SC). An EC phase is the one in which the active ingredient is dissolved in an oil/solvent. A SC phase is the one in which the active ingredient is suspended in a water/liquid medium. When the two concentrates, EC and SC, are mixed to form a suspoemulsion, water/liquid medium serves as the continuous phase in the suspoemulsion, carrying oil droplets as the dispersed phase containing one active ingredient along with suspended particles of another active ingredient. Generally, the SC and EC phases as well as the resulting SE formulation additionally contain other components such as a surfactant, to aid the stability of the suspoemulsion and hence of the whole composition.

The inventors of the present disclosure found that a stable agrochemical composition of a benzoylphenylurea insecticide and a pyrethroid insecticide can be prepared in a form of a suspoemulsion using a crystallization controlling system comprising low HLB block copolymer surfactant and a high HLB block copolymer surfactant. Inventors of the present disclosure found that a stable suspoemulsion of a pyrethroid insecticide in combination with a benzoylphenylurea insecticide can be prepared by controlling crystal growth associated with the benzoylphenylurea insecticide using a crystallization controlling system comprising a low hydrophile-lipophile balance (HLB) block copolymer surfactant and a high HLB block copolymer surfactant. It was found that the presence of both high HLB surfactant and low HLB surfactant stabilizes the suspoemulsion composition sterically and balances the intermolecular forces between the active ingredient particles thereby retarding crystal growth on the suspended particles of the benzoylphenylurea insecticide in the suspoemulsion composition. Therefore, combining a low HLB surfactant ranging from about 4 to about 7 with a high HLB surfactant ranging from about 12 to about 18 was found to be suitable for controlling crystal growth in the suspoemulsion composition of benzoylphenylurea insecticide and pyrethroid insecticide.

Accordingly in an embodiment, the present disclosure provides an agrochemical composition.

In a preferred embodiment, the present disclosure provides a stable agrochemical composition.

Accordingly in an embodiment, the present disclosure provides an insecticidal composition.

In a preferred embodiment, the present disclosure provides a stable insecticidal composition.

According to an embodiment, the present disclosure provides an agrochemical composition comprising:
a suspension phase;
an emulsion phase; and
a crystallization controlling system.

According to an embodiment, the present disclosure provides an insecticidal composition comprising:
a suspension phase;
an emulsion phase; and
a crystallization controlling system.

According to an embodiment, the present disclosure provides an insecticidal composition comprising:
a suspension phase comprising a benzoylphenylurea insecticide;
an emulsion phase comprising a pyrethroid insecticide; and
a crystallization controlling system comprising at least two surfactants.

According to an embodiment, the present disclosure provides a suspoemulsion composition comprising:
a suspension phase comprising a benzoylphenylurea insecticide;
an emulsion phase comprising a pyrethroid insecticide; and
a crystallization controlling system comprising at least two surfactants.

According to an embodiment, the present disclosure provides a stable suspoemulsion composition comprising:
a suspension phase comprising a benzoylphenylurea insecticide;
an emulsion phase comprising a pyrethroid insecticide; and
a crystallization controlling system comprising at least two surfactants.

According to an embodiment of the present disclosure, the benzoylphenylurea insecticide is selected from the group comprising diflubenzuron, bistrifluron, chlorbenzuron, chlorfluazuron, dichlorbenzuron, flucycloxuron, flufenoxuron, hexaflumuron, lufenuron, novaluron, noviflumuron, penfluron, teflubenzuron, triflumuron, and combinations thereof.

According to an embodiment of the present disclosure, the benzoylphenylurea insecticide is selected from the group comprising diflubenzuron, novaluron, lufenuron, and combinations thereof.

In a preferred embodiment of the present disclosure, the benzoylphenylurea insecticide is diflubenzuron.

In a preferred embodiment of the present disclosure, the benzoylphenylurea insecticide is novaluron.

In a preferred embodiment of the present disclosure, the benzoylphenylurea insecticide is lufenuron.

According to an embodiment of the present disclosure, the composition comprises from about 0.1% w/w to about 60% w/w, and preferably from about 0.5% w/w to about 50% w/w, of the benzoylphenylurea insecticide of total weight of the composition.

In a preferred embodiment of the present disclosure, the composition comprises from about 1% w/w to about 40% w/w of the benzoylphenylurea insecticide of total weight of the composition.

According to an embodiment of the present disclosure, the suspension phase of the suspoemulsion composition further comprises dispersing agents, viscosity modifiers, antifreeze agents, antifoams, biocides, water, and combinations thereof.

According to an embodiment of the present disclosure, the pyrethroid insecticide is selected from the group comprising lambda-cyhalothrin, bifenthrin, cypermethrin, gamma-cyhalothrin, deltamethrin, transfluthrin, permethrin, cyhalothrin, and combinations thereof.

In a preferred embodiment of the present disclosure, the pyrethroid insecticide is lambda-cyhalothrin.

In a preferred embodiment of the present disclosure, the pyrethroid insecticide is bifenthrin.

In a preferred embodiment of the present disclosure, the pyrethroid insecticide is cypermethrin.

According to an embodiment of the present disclosure, the composition comprises from about 0.1% w/w to about 60% w/w, and preferably from about 0.5% w/w to about 50% w/w of the pyrethroid insecticide of total weight of the composition.

In a preferred embodiment of the present disclosure, the composition comprises from about 1% w/w to about 40% w/w of the pyrethroid insecticide of total weight of the composition.

According to an embodiment of the present disclosure, the emulsion phase of the suspoemulsion composition further comprises one or more solvents. Suitable solvents comprise aromatic hydrocarbons, for example, high solvency C₁₁ aromatic fluid, heavy aromatic solvent naphtha (petroleum), hexamethylene diisocyanate (HDI) resin, polypropylene homopolymer, N-methyl pyrrolidone, methyl oleate, propylene carbonate, N-octyl pyrrolidone, cyclohexyl-1-pyrrolidone, mixtures of paraffinic, isoparaffinic, cycloparaffinic hydrocarbons, and combinations thereof. According to a preferred embodiment of the present disclosure, the benzoylphenylurea insecticide and the pyrethroid insecticide may be present in the composition in any amount relative to each other. In particular, a weight ratio of the benzoylphenylurea insecticide and the pyrethroid insecticide in the composition is preferably in a range of from about 60:1 to about 1:60, 40:1 to about 1:40, or from about 15:1 to about 1:15, more preferably from about 10:1 to about 1:10, from about 5:1 to about 1:5, or from about 2:1 to about 1:2.

According to an embodiment of the present disclosure, the composition comprises a crystallization controlling system comprising at least two surfactants.

In a preferred embodiment, the crystallization controlling system comprising at least two surfactants is selected from a low HLB block copolymer surfactant and a high HLB block copolymer surfactant.

In a preferred embodiment, the crystallization controlling system of the composition comprises a low HLB block copolymer surfactant and a high HLB block copolymer surfactant.

In a preferred embodiment, the crystallization controlling system of the composition comprises a low HLB block copolymer surfactant and a high HLB block copolymer surfactant in a weight ratio ranging from about 0.5:1 to about 0.5:5.

According to an embodiment of the present disclosure, a suspoemulsion composition comprising:
a suspension phase comprising a benzoylphenylurea insecticide;
an emulsion phase comprising a pyrethroid insecticide; and
a crystallization controlling system comprising a low HLB block copolymer surfactant and a high HLB block copolymer surfactant in a weight ratio ranging from about 0.5:1 to about 0.5:5.

According to an embodiment of the present disclosure, a suspoemulsion composition comprising:
a suspension phase comprising a benzoylphenylurea insecticide;
an emulsion phase comprising a pyrethroid insecticide; and
a crystallization controlling system comprising a low HLB block copolymer surfactant and a high HLB block copolymer surfactant in a weight ratio ranging from about 1:1 to about 1:5.

According to an embodiment of the present disclosure, the low HLB block copolymer surfactant of the crystallization controlling system has HLB scale ranging from about 4 to about 7.

According to an embodiment of the present disclosure, the low HLB block copolymer surfactant is selected from the group comprising block copolymers of polyethylene glycol (PEG) and polyhydroxystearic acid such as PEG-30 dipolyhydroxystearate and non-ionic block copolymer; random copolymer of poly alkyd resin with polyethylene glycol such as non-ionic random polymeric; polymeric ester such as high molecular weight polymer, polyoxyethylene polyoxypropylene block copolymer, and combinations thereof.

In a preferred embodiment, the low HLB block copolymer surfactant is selected from the group comprising block copolymers of polyethylene glycol and polyhydroxystearic acid, random copolymer of poly alkyl resin with polyethylene glycol and polymeric ester, polyoxyethylene polyoxypropylene block copolymer, and combinations thereof.

According to an embodiment of the present disclosure, the high HLB block copolymer surfactant of the crystallization controlling system has HLB scale ranging from about 12 to about 18.

According to an embodiment of the present disclosure, the high HLB block copolymer surfactant is selected from the group comprising hydrophilic methyl methacrylate graft copolymer such as acrylic copolymer solution, polyoxyethylene (20) C₁₂-C₁₅ alcohol, block copolymeric alkoxylates such as polyalkylene glycol ether and polyalkylene oxide block copolymer, and combinations thereof.

In a preferred embodiment, the high HLB block copolymer surfactant is selected from the group comprising hydrophilic methyl methacrylate graft copolymer and block copolymeric alkoxylates made by polyalkylene glycol ether and polyalkylene oxide block copolymer, and combinations thereof.

According to an embodiment of the present disclosure, the crystallization controlling system comprises block copolymers of polyethylene glycol (PEG) and polyhydroxystearic acid; and block copolymeric alkoxylates.

According to an embodiment of the present disclosure, the crystallization controlling system comprises block copolymers of polyethylene glycol and polyhydroxystearic acid; and hydrophilic methyl methacrylate graft copolymer.

According to an embodiment of the present disclosure, the crystallization controlling system comprises random copolymer of poly alkyd resin with PEG; and block copolymeric alkoxylates.

According to an embodiment of the present disclosure, the crystallization controlling system comprises random copolymer of poly alkyd resin with PEG; and hydrophilic methyl methacrylate graft copolymer.

According to an embodiment of the present disclosure, the composition comprises from about 0.01% w/w to about 10% w/w, and preferably from about 0.1% w/w to about 10% w/w of the crystallization controlling system of total weight of the composition.

In a preferred embodiment of the present disclosure, the composition comprises from about 0.5% w/w to about 10% w/w of the crystallization controlling system of total weight of the composition.

According to an embodiment of the present disclosure, the low HLB block copolymer surfactant and the high HLB block copolymer surfactant are in a weight ratio ranging from about 0.5:1 to about 0.5:5.

In a preferred embodiment of the present disclosure, the low HLB block copolymer surfactant and the high HLB block copolymer surfactant are in a weight ratio of about 0.5:1.

In a preferred embodiment of the present disclosure, the low HLB block copolymer surfactant and the high HLB block copolymer surfactant are in a weight ratio of about 0.5:1.5.

In a preferred embodiment of the present disclosure, the low HLB block copolymer surfactant and the high HLB block copolymer surfactant are in a weight ratio of about 0.5:2.

According to an embodiment of the present disclosure, the low HLB block copolymer surfactant and the high HLB block copolymer surfactant are in a weight ratio ranging from about 1:1 to about 1:5.

In a preferred embodiment of the present disclosure, the low HLB block copolymer surfactant and the high HLB block copolymer surfactant are in a weight ratio of about 1:2.

In a preferred embodiment of the present disclosure, the low HLB block copolymer surfactant and the high HLB block copolymer surfactant are in a weight ratio of about 1:3.

In a preferred embodiment of the present disclosure, the low HLB block copolymer surfactant and the high HLB block copolymer surfactant are in a weight ratio of about 1:3.5.

According to an embodiment of the present disclosure, the crystallization controlling system comprises from about 0.01% w/w to about 10% w/w of the low HLB block copolymer surfactant and from about 0.01% w/w to about 10% w/w of the high HLB block copolymer surfactant of total weight of the crystallization controlling system, wherein the low HLB block copolymer surfactant and the high HLB block copolymer surfactant are in a weight ratio ranging from about 0.5:1 to about 0.5:5.

In a preferred embodiment of the present disclosure, the crystallization controlling system comprises from about 0.1% w/w to about 10% w/w of the low HLB block copolymer surfactant and from about 0.1% w/w to about 10% w/w of the high HLB block copolymer surfactant of total weight of the crystallization controlling system, wherein the low HLB block copolymer surfactant and the high HLB block copolymer surfactant are in a weight ratio ranging from about 0.5:1 to about 0.5:5.

In a preferred embodiment of the present disclosure, the crystallization controlling system comprises from about 0.5% w/w to about 10% w/w of the low HLB block copolymer surfactant and from about 0.5% w/w to about 10% w/w of the high HLB block copolymer surfactant of total weight of the crystallization controlling system, wherein the low HLB block copolymer surfactant and the high HLB block copolymer surfactant are in a weight ratio ranging from about 0.5:1 to about 0.5:5.

According to an embodiment of the present disclosure, a suspoemulsion composition comprising:
a suspension phase comprising a benzoylphenylurea insecticide;
an emulsion phase comprising a pyrethroid insecticide;
a crystallization controlling system comprising a low HLB block copolymer surfactant and a high HLB block copolymer surfactant in a weight ratio ranging from about 0.5:1 to about 0.5:5; and
optionally at least one agrochemically acceptable excipient.

In a preferred embodiment of the present disclosure, a suspoemulsion composition comprising:
a suspension phase comprising diflubenzuron;
an emulsion phase comprising lambda-cyhalothrin;
a crystallization controlling system comprising a low HLB block copolymer surfactant and a high HLB block copolymer surfactant in a weight ratio ranging from about 0.5:1 to about 0.5:5; and
optionally at least one agrochemically acceptable excipient.

According to an embodiment of the present disclosure, a suspoemulsion composition comprising:
a suspension phase comprising diflubenzuron;
an emulsion phase comprising lambda-cyhalothrin; and
a crystallization controlling system comprising block copolymers (A-B-A) of polyethylene glycol and polyhydroxystearic acid and block copolymeric alkoxylates in a weight ratio of about 0.5:2; and
optionally at least one agrochemically acceptable excipient.

According to an embodiment of the present disclosure, the suspoemulsion composition comprises from about 0.1% w/w to about 60% w/w benzoylphenylurea insecticide in the suspension phase, from about 0.1% w/w to about 60% w/w pyrethroid insecticide in the emulsion phase; from about 0.01% w/w to about 10% w/w crystallization controlling system, and from about 1% w/w to about 30% w/w agrochemically acceptable excipient of total weight of the suspoemulsion composition.

According to an embodiment of the present disclosure, the suspoemulsion composition comprises from about 0.5% w/w to about 50% w/w benzoylphenylurea insecticide in the suspension phase, from about 0.5% w/w to about 50% w/w pyrethroid insecticide in the emulsion phase; and from about 0.1% w/w to about 10% w/w crystallization controlling system of total weight of the suspoemulsion composition.

According to an embodiment of the present disclosure, the suspoemulsion composition comprises from about 1% w/w to about 40% w/w benzoylphenylurea insecticide in the suspension phase, from about 1% w/w to about 40% w/w pyrethroid insecticide in the emulsion phase; and from about 0.5% w/w to about 10% w/w crystallization controlling system of total weight of the stable suspoemulsion composition.

According to an embodiment of the present disclosure, the suspoemulsion composition comprises from about 0.1% w/w to about 60% w/w benzoylphenylurea insecticide in the suspension phase, from about 0.1% w/w to about 60% w/w pyrethroid insecticide in the emulsion phase; from about 0.01% w/w to about 10% w/w low HLB block copolymer surfactant; and from about 0.01% w/w to about 10% w/w high HLB block copolymer surfactant of total weight of the suspoemulsion composition; wherein the low HLB block copolymer surfactant and the high HLB block copolymer surfactant are in a weight ratio ranging from about 0.5:1 to about 0.5:5.

According to an embodiment of the present disclosure, the suspoemulsion composition comprises from about 0.5% w/w to about 50% w/w benzoylphenylurea insecticide in the suspension phase, from about 0.5% w/w to about 50% w/w pyrethroid insecticide in the emulsion phase; from about 0.1% w/w to about 10% w/w low HLB block copolymer surfactant; and from about 0.1% w/w to about 10% w/w high HLB block copolymer surfactant of total weight of the suspoemulsion composition; wherein the low HLB block copolymer surfactant and the high HLB block copolymer surfactant are in a weight ratio ranging from about 0.5:1 to about 0.5:5.

According to an embodiment of the present disclosure, the suspoemulsion composition comprises from about 1% w/w to about 40% w/w benzoylphenylurea insecticide in the suspension phase, from about 1% w/w to about 40% w/w pyrethroid insecticide in the emulsion phase; from about 0.5% w/w to about 10% w/w low HLB block copolymer surfactant; and from about 0.5% w/w to about 10% w/w high HLB block copolymer surfactant of total weight of the suspoemulsion composition; wherein the low HLB block copolymer surfactant and the high HLB block copolymer surfactant are in a weight ratio ranging from about 0.5:1 to about 0.5:5.

According to an embodiment of the present disclosure, the suspoemulsion composition comprises from about 0.1% w/w to about 60% w/w diflubenzuron in the suspension phase, from about 0.1% w/w to about 60% w/w lambda-cyhalothrin insecticide in the emulsion phase; and from about 0.01% w/w to about 10% w/w crystallization controlling system of total weight of the suspoemulsion composition.

According to an embodiment of the present disclosure, the suspoemulsion composition comprises from about 0.5% w/w to about 50% w/w diflubenzuron in the suspension phase, from about 0.5% w/w to about 50% w/w lambda-cyhalothrin in the emulsion phase; and from about 0.1% w/w to about 10% w/w crystallization controlling system of total weight of the suspoemulsion composition.

According to an embodiment of the present disclosure, the suspoemulsion composition comprises from about 1% w/w to about 40% w/w diflubenzuron in the suspension phase, from about 1% w/w to about 40% w/w lambda-cyhalothrin in the emulsion phase; and from about 0.5% w/w to about 10% w/w crystallization controlling system of total weight of the suspoemulsion composition.

According to an embodiment of the present disclosure, the suspoemulsion composition comprises from about 0.1% w/w to about 60% w/w diflubenzuron in the suspension phase, from about 0.1% w/w to about 60% w/w lambda-cyhalothrin in the emulsion phase; from about 0.01% w/w to about 10% w/w low HLB block copolymer surfactant; and from about 0.01% w/w to about 10% w/w high HLB block copolymer surfactant of total weight of the suspoemulsion composition;

wherein the low HLB block copolymer surfactant and the high HLB block copolymer surfactant are in a weight ratio ranging from about 0.5:1 to about 0.5:5.

According to an embodiment of the present disclosure, the suspoemulsion composition comprises from about 0.5% w/w to about 50% w/w diflubenzuron in the suspension phase, from about 0.5% w/w to about 50% w/w lambda-cyhalothrin in the emulsion phase; from about 0.1% w/w to about 10% w/w low HLB block copolymer surfactant; and from about 0.1% w/w to about 10% w/w high HLB block copolymer surfactant of total weight of the suspoemulsion composition; wherein the low HLB block copolymer surfactant and the high HLB block copolymer surfactant are in a weight ratio ranging from about 0.5:1 to about 0.5:5.

According to an embodiment of the present disclosure, the suspoemulsion composition comprises from about 1% w/w to about 40% w/w diflubenzuron in the suspension phase, from about 1% w/w to about 40% w/w lambda-cyhalothrin in the emulsion phase; from about 0.5% w/w to about 10% w/w low HLB block copolymer surfactant; and from about 0.5% w/w to about 10% w/w high HLB block copolymer surfactant of total weight of the suspoemulsion composition; wherein the low HLB block copolymer surfactant and the high HLB block copolymer surfactant are in a weight ratio ranging from about 0.5:1 to about 0.5:5.

According to an embodiment of the present disclosure, the agrochemically acceptable excipient comprises one or more surfactants/dispersing agents, antifreeze agent, wetting agents, antifoaming agents, emulsifiers/thickeners, preservatives, colorants, fillers, antioxidants, solvent, and other formulation aids.

According to an embodiment of the present disclosure, the surfactants/dispersing agents comprise anionic surfactants and non-ionic surfactants. The anionic surfactants are selected the group comprising alkyl and aryl sulfates and sulfonates, including sodium alkyl sulfates, sodium mono- and di-alkyl naphthalene sulfonates, sodium alpha-olefin sulfonate, lignin and its derivatives (such as lignosulfonate salts, sodium lignosulfonate), sodium alkane sulfonates, polyoxyalkylene alkylether sulfate, polyoxyalkylene alkylaryl ether sulfates, polyoxyalkylene styrylphenyl ether sulfate, mono- and di-alkylbenzene sulfonates, alkylnaphthalene sulfonate, alkylnaphthalene sulfonate formaldehyde condensate, alkyl diphenylether sulfonates, alkylphosphates, polyoxyalkylene alkyl phosphates, polyoxyalkylene phenylether phosphate, polyoxyalkylphenol phosphates, poly-carboxylates, fatty acids and salts thereof, alkyl glycinates, sulfonated methyl esters, sulfonated fatty acids, sulfosuccinates and their derivatives, acyl glutamates, acyl sarcosinates, alkyl sulfoacetates, acylated peptides, alkyl ether carboxylates, acyl lactylates and mixtures thereof. The non-ionic surfactants are selected from the group comprising ethoxylated fatty acids, alcohol ethoxylates, tristyrylphenol ethoxylates, ethoxylated sorbitan fatty acid esters (examples include polyoxyethylene sorbitan esters widely known as polysorbates), and combinations thereof.

According to an embodiment of the present disclosure, suitable antifreeze agents comprise liquid polyols, for example ethylene glycol, propylene glycol or glycerol.

According to an embodiment of the present disclosure, wetting agents comprise polyarylalkoxylated phosphate esters and their potassium salts (e.g., ethoxylated tristyrylphenol phosphate potassium salt, tristrylphenol ethoxylate). Other suitable wetting agents include sodium dioctylsulfosuccinates (e.g., sodium dioctylsulfosuccinate, diethylhexyl sodium sulfosuccinate) and ethoxylated alcohols (e.g., polyethylene glycol ether of Tridecyl Alcohol; alcohol ethoxylate; Alcohols, C₁₂₋₁₆, ethoxylated).

According to an embodiment of the present disclosure, antifoaming agents are selected from the group comprising silicone-based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination thereof. Examples of defoamers comprise silicone antifoam emulsions and combinations thereof.

According to an embodiment of the present disclosure, emulsifiers/thickeners comprise anionic heteropolysaccharides from the xanthan gum group, rheology modifiers, attapulgite clay, polymeric surfactant, and combinations thereof.

According to an embodiment of the present disclosure, the preservatives used comprise benzisothiazolinone or phenols, 2-bromo-2-nitropropane-1,3-diol, 5-chloro-2-methyl-4-isothiazolin-3-one 2-methyl-4-isothiazolin-3-one, Glutaraldehyde, Chloromethylisothiazolinone (CMIT)/Methylisothiazolinone (MIT), 2.2-dibromo-3-nitrilopropioamide, Natamycin and Nisin, Bronopol/CMIT/MIT, and combinations thereof.

According to an embodiment of the present disclosure, suitable colorants (for example in red, blue and green) are, preferably, pigments, which are sparingly soluble in water, and dyes, which are water-soluble. Examples are inorganic coloring agents (for example iron oxide, titanium oxide, and iron hexacyanoferrate) and organic coloring agents (for example alizarin, azo and phthalocyanin coloring agents).

According to an embodiment of the present disclosure, the fillers may include an organic or inorganic solid inert substance such as talc, clay, diatomaceous earth, magnesium aluminum silicate, white carbon black, pyrophyllite, light calcium carbonate, high clay, organic bentonite, and combinations thereof.

In another embodiment, antioxidants are, for example, amino acids (e.g., glycine, histidine, tyrosine, tryptophan) and derivatives thereof, imidazole and imidazole derivatives (e.g., urocanic acid), peptides, such as, for example, D,L-carnosine, D-carnosine, L-carnosine and derivatives thereof (e.g., anserine), carotenoids, carotenes (e.g., a-carotene, β-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g., buthionine sulfoximines, homocysteine sulfoximine, buthionine sulfones, penta-, hexa-, heptathionine sulfoximine) in very low tolerated doses (e.g., pmol/kg to pmol/kg), also metal chelating agents (e.g., a-hydroxy fatty acids, EDTA, EGTA, phytic acid, lactoferrin), a-hydroxy acids (e.g., citric acid, lactic acid, malic acid), humic acids, bile acid, bile extracts, gallic esters (e.g., propyl, octyl and dodecyl gallate), flavonoids, catechins, bilirubin, biliverdin and derivatives thereof, unsaturated fatty acids and derivatives thereof (e.g., y-linolenic acid, linoleic acid, arachidonic acid, oleic acid), folic acid and derivatives thereof, hydroquinone and derivatives thereof (e.g., arbutin), ubiquinone and ubiquinol, and derivatives thereof, vitamin C and derivatives thereof (e.g., ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g., selenomethionine), stilbenes and stilbene derivatives (e.g., stilbene oxide, trans-stilbene oxide). According to the disclosure, suitable derivatives (salts, esters, sugars, nucleotides, nucleosides, peptides, and lipids) and mixtures of these specified active ingredients or plant extracts (e.g., tea tree oil, rosemary extract and rosemarinic acid) which comprise these antioxidants can be used. In general, mixtures of the aforementioned antioxidants are possible.

According to an embodiment, examples of suitable solvents are water, oils of vegetable, cyclohexanone, 2-butoxyethanol, or derivatives thereof. In principle, solvent mixtures may also be used.

According to an embodiment of the present disclosure, examples of suitable biocides are benzisothiazolin (BIT) solution and examples of suitable stabilizers are phosphoric acid solution.

According to an embodiment, the suspoemulsion composition comprises from about 1% w/w to about 30% w/w agrochemically acceptable excipient of total weight of the suspoemulsion composition.

According to an embodiment of the present disclosure, the suspoemulsion composition comprises from about 0.1% w/w to about 60% w/w diflubenzuron in the suspension phase, from about 0.1% w/w to about 60% w/w lambda-cyhalothrin in the emulsion phase, from about 0.01% w/w to about 10% w/w low HLB block copolymer surfactant and from about 0.01% w/w to about 10% w/w high HLB block copolymer surfactant, and from about 1% w/w to about 30% w/w agrochemically acceptable excipient of total weight of the suspoemulsion composition; wherein the low HLB block copolymer surfactant and the high HLB block copolymer surfactant are in a weight ratio ranging from about 0.5:1 to about 0.5:5.

According to an embodiment of the present disclosure, the suspoemulsion composition comprises from about 0.5% w/w to about 50% w/w diflubenzuron in the suspension phase, from about 0.5% w/w to about 50% w/w lambda-cyhalothrin in the emulsion phase, from about 0.1% w/w to about 10% w/w low HLB block copolymer surfactant, and from about 0.1% w/w to about 10% w/w high HLB block copolymer surfactant, and from about 1% w/w to about 30% w/w agrochemically acceptable excipient of total weight of the suspoemulsion composition; wherein the low HLB block copolymer surfactant and the high HLB block copolymer surfactant are in a weight ratio ranging from about 0.5:1 to about 0.5:5.

According to an embodiment of the present disclosure, the suspoemulsion composition comprises from about 1% w/w to about 40% w/w diflubenzuron in the suspension phase, from about 1% w/w to about 40% w/w lambda-cyhalothrin in the emulsion phase, from about 0.5% w/w to about 10% w/w low HLB block copolymer surfactant and from about 0.5% w/w to about 10% w/w high HLB block copolymer surfactant, and from about 1% w/w to about 30% w/w agrochemically acceptable excipient of total weight of the suspoemulsion composition; wherein the low HLB block copolymer surfactant and the high HLB block copolymer surfactant are in a weight ratio ranging from about 0.5:1 to about 0.5:5.

In an embodiment, the composition of the present disclosure is produced by combining the benzoylphenylurea insecticide, the pyrethroid insecticide, and the crystallization controlling system with optionally at least one agrochemically acceptable excipient to prepare a mixture and formulating the mixture into a liquid formulation.

In an embodiment, the liquid formulation is selected from Capsule suspension (CS), Dispersible concentrate (DC), Emulsion, water in oil (EO), Emulsion, oil in water (EW), Oil dispersion (OD), Oil miscible flowable concentrate (oil miscible suspension (OF), Oil miscible liquid (OL), Suspension concentrate (SC), soluble concentrate (SL) or Suspoemulsion (SE).

In a preferred embodiment, the present disclosure provides an agrochemical composition in a form of a suspoemulsion.

In a preferred embodiment, the present disclosure provides an insecticidal composition in a form of a suspoemulsion.

In a preferred embodiment, the present disclosure provides a stable suspoemulsion composition.

According to an embodiment of the present disclosure, a suspoemulsion composition comprising:
a suspension phase comprising a benzoylphenylurea insecticide;
an emulsion phase comprising a pyrethroid insecticide; and
a crystallization controlling system comprising a low HLB block copolymer surfactant and a high HLB block copolymer surfactant in a weight ratio ranging from about 0.5:1 to about 0.5:5.

According to an embodiment of the present disclosure, a suspoemulsion composition comprising:
a suspension phase comprising a benzoylphenylurea insecticide;
an emulsion phase comprising a pyrethroid insecticide;
a crystallization controlling system comprising a low HLB block copolymer surfactant and a high HLB block copolymer surfactant in a weight ratio ranging from about 0.5:1 to about 0.5:5; and
optionally at least one agrochemically acceptable excipient.

According to an embodiment of the present disclosure, a suspoemulsion composition comprising:
a suspension phase comprising a benzoylphenylurea insecticide;
an emulsion phase comprising a pyrethroid insecticide;
a crystallization controlling system comprising a low HLB block copolymer surfactant and a high HLB block copolymer surfactant in a weight ratio ranging from about 0.5:1 to about 0.5:5;
   wherein the suspoemulsion composition is present in a form of a tank mix or a pre-formulated (pre-mix)/ready-mix formulation.

According to an embodiment of the present disclosure, a suspoemulsion composition comprising:
a suspension phase comprising a benzoylphenylurea insecticide;
an emulsion phase comprising a pyrethroid insecticide;
a crystallization controlling system comprising a low HLB block copolymer surfactant and a high HLB block copolymer surfactant in a weight ratio ranging from about 0.5:1 to about 0.5:5; and
optionally at least one agrochemically acceptable excipient;
   wherein the suspoemulsion composition is present in a form of a tank mix or a pre-formulated (pre-mix)/ready-mix formulation.

In another embodiment, the suspoemulsion composition disclosed herein may be applied simultaneously as a tank mix or together as a pre-mix formulation, or each insecticide may be applied sequentially.

In yet another embodiment, the suspoemulsion composition may be applied as a pre-emergence application or a post-emergence application.

According to an embodiment, the present disclosure provides a suspoemulsion composition in a form of a tank mix formulation.

According to an embodiment, the present disclosure provides a suspoemulsion composition in a form of a (pre-mix)/ready-mix formulation.

According to an embodiment of the present disclosure, a pre-mix suspoemulsion composition comprising:
a suspension phase comprising a benzoylphenylurea insecticide;
an emulsion phase comprising a pyrethroid insecticide; and
a crystallization controlling system comprising a low HLB block copolymer surfactant and a high HLB block copolymer surfactant in a weight ratio ranging from about 0.5:1 to about 0.5:5.

According to an embodiment of the present disclosure, a pre-mix suspoemulsion composition comprising:
a suspension phase comprising diflubenzuron;
an emulsion phase comprising lambda-cyhalothrin; and
a crystallization controlling system comprising a low HLB block copolymer surfactant and a high HLB block copolymer surfactant in a weight ratio ranging from about 0.5:1 to about 0.5:5.

According to an embodiment of the present disclosure, a pre-mix suspoemulsion composition comprising:
a suspension phase comprising a benzoylphenylurea insecticide;
an emulsion phase comprising a pyrethroid insecticide;
a crystallization controlling system comprising a low HLB block copolymer surfactant and a high HLB block copolymer surfactant in a weight ratio ranging from about 0.5:1 to about 0.5:5; and
optionally at least one agrochemically acceptable excipient.

According to an embodiment of the present disclosure, a pre-mix suspoemulsion composition comprising:
a suspension phase comprising a benzoylphenylurea insecticide;
an emulsion phase comprising a pyrethroid insecticide;
a crystallization controlling system comprising a low HLB block copolymer surfactant and a high HLB block copolymer surfactant in a weight ratio ranging from about 0.5:1 to about 0.5:5; and
optionally at least one agrochemically acceptable excipient.

According to an embodiment of the present disclosure, the suspoemulsion composition has a particle size distribution (D50) ranging from about 1.0 μm to about 3.0 μm.

According to an embodiment of the present disclosure, the suspoemulsion composition has a particle size distribution (D50) ranging from about 1 μm to about 2.5 μm.

According to an embodiment of the present disclosure, the suspoemulsion composition has a particle size distribution (D50) ranging from about 1.5 μm to about 2.5 μm.

According to an embodiment of the present disclosure, the suspoemulsion composition has a particle size distribution (D50) ranging from about 1.8 μm to about 2.5 μm.

According to an embodiment of the present disclosure, the suspoemulsion composition has a particle size distribution (D50) ranging from about 2.0 μm to about 2.5 μm.

According to an embodiment of the present disclosure, the suspoemulsion composition has a particle size distribution (D90) ranging from about 4.0 μm to about 10.0 μm.

According to an embodiment of the present disclosure, the suspoemulsion composition has a particle size distribution (D90) ranging from about 3.5 μm to about 9.5 μm.

According to an embodiment of the present disclosure, the suspoemulsion composition has a particle size distribution (D90) ranging from about 3.5 μm to about 9.0 μm.

According to an embodiment of the present disclosure, the suspoemulsion composition has a particle size distribution (D90) ranging from about 3.5 μm to about 9.0 μm.

According to an embodiment of the present disclosure, the suspoemulsion composition has a particle size distribution (D90) ranging from about 4.5 μm to about 9.0 μm.

According to an embodiment of the present disclosure, the suspoemulsion composition comprises a particle size distribution as D50 ranging from about 1.0 μm to about 3.0 μm and D90 ranging from about 4.0 μm to about 10.0 μm.

According to an embodiment of the present disclosure, the suspoemulsion composition has a viscosity value ranging from about 250 to about 500 centipoises (cps).

According to an embodiment of the present disclosure, the suspoemulsion composition has a viscosity value ranging from about 280 to about 500 cps.

According to an embodiment of the present disclosure, the suspoemulsion composition has a viscosity value ranging from about 300 to about 500 cps.

According to an embodiment of the present disclosure, the suspoemulsion composition has a viscosity value ranging from about 350 to about 500 cps.

According to an embodiment of the present disclosure, the suspoemulsion composition has a viscosity value ranging from about 400 to about 500 cps.

According to an embodiment, the present disclosure provides use of an agricultural composition comprising a suspension phase comprising a benzoylphenylurea insecticide; an emulsion phase comprising a pyrethroid insecticide; and a crystallization controlling system comprising at least two surfactants, for controlling growth of insects/pests in plants.

According to an embodiment, the present disclosure provides use of an insecticidal composition for controlling growth of insects/pests in plants, wherein the insecticidal composition comprises:
a suspension phase comprising a benzoylphenylurea insecticide;
an emulsion phase comprising a pyrethroid insecticide; and
a crystallization controlling system comprising at least two surfactants.

In a preferred embodiment, the present disclosure provides use of a suspoemulsion composition for controlling growth of insects/pests in plants, wherein the suspoemulsion composition comprises:
a suspension phase comprising a benzoylphenylurea insecticide;
an emulsion phase comprising a pyrethroid insecticide; and
a crystallization controlling system comprising at least two surfactants.

In a preferred embodiment, the present disclosure provides use of a suspoemulsion composition for controlling growth of insects/pests in plants, wherein the suspoemulsion composition comprises:
a suspension phase comprising a benzoylphenylurea insecticide;
an emulsion phase comprising a pyrethroid insecticide; and
a crystallization controlling system comprising at least two surfactants in a weight ratio ranging from about 0.5:1 to about 0.5:5.

In a preferred embodiment, the present disclosure provides use of a suspoemulsion composition for controlling growth of insects/pests in plants, wherein the suspoemulsion composition comprises:
a suspension phase comprising a benzoylphenylurea insecticide;
an emulsion phase comprising a pyrethroid insecticide; and
a crystallization controlling system comprising a low HLB block copolymer surfactant and a high HLB block copolymer surfactant in a weight ratio ranging from about 0.5:1 to about 0.5:5.

In a preferred embodiment, the present disclosure provides use of a suspoemulsion composition for controlling growth of insects/pests in plants, wherein the suspoemulsion composition comprises:
a suspension phase comprising a benzoylphenylurea insecticide;
an emulsion phase comprising a pyrethroid insecticide;
a crystallization controlling system comprising a low HLB block copolymer surfactant and a high HLB block copolymer surfactant in a weight ratio ranging from about 0.5:1 to about 0.5:5; and
optionally at least one agrochemically acceptable excipient.

In a preferred embodiment, the present disclosure provides use of a suspoemulsion composition for controlling growth of insects/pests in plants, wherein the suspoemulsion composition comprises:
a suspension phase comprising diflubenzuron;
an emulsion phase comprising lambda-cyhalothrin; and
a crystallization controlling system comprising a low HLB block copolymer surfactant and a high HLB block copolymer surfactant in a weight ratio ranging from about 0.5:1 to about 0.5:5.

In a preferred embodiment, the present disclosure provides use of a suspoemulsion composition for controlling growth of insects/pests in plants, wherein the suspoemulsion composition comprises:
a suspension phase comprising diflubenzuron;
an emulsion phase comprising lambda-cyhalothrin;
a crystallization controlling system comprising a low HLB block copolymer surfactant and a high HLB block copolymer surfactant in a weight ratio ranging from about 0.5:1 to about 0.5:5; and
optionally at least one agrochemically acceptable excipient.

In another embodiment, the suspoemulsion composition may be applied before or after infection of the plants or the propagation material thereof, by the insects/pests.

In another embodiment, the suspoemulsion composition may be used for foliar application, application to a ground or to a plant, or a locus, or a plant propagation material, or combinations thereof.

In another embodiment, the suspoemulsion composition may be used for application to the insects/pests or to their locus thereof.

According to an embodiment, the present disclosure provides a process for preparation of the suspoemulsion composition, wherein the suspoemulsion composition comprises:
a suspension phase comprising a benzoylphenylurea insecticide;
an emulsion phase comprising a pyrethroid insecticide; and
a crystallization controlling system comprising at least two surfactants.

In a preferred embodiment, the present disclosure provides a process for preparation of the suspoemulsion composition, wherein the suspoemulsion composition comprises:
a suspension phase comprising a benzoylphenylurea insecticide;
an emulsion phase comprising a pyrethroid insecticide; and
a crystallization controlling system comprising at least two surfactants in a weight ratio ranging from about 0.5:1 to about 0.5:5.

In a preferred embodiment, the present disclosure provides a process for preparation of the suspoemulsion composition, wherein the suspoemulsion composition comprises:
a suspension phase comprising a benzoylphenylurea insecticide;
an emulsion phase comprising a pyrethroid insecticide; and
a crystallization controlling system comprising a low HLB block copolymer surfactant and a high HLB block copolymer surfactant in a weight ratio ranging from about 0.5:1 to about 0.5:5.

In a preferred embodiment, the present disclosure provides a process for preparation of the suspoemulsion composition, wherein the suspoemulsion composition comprises:
a suspension phase comprising a benzoylphenylurea insecticide;
an emulsion phase comprising a pyrethroid insecticide;
a crystallization controlling system comprising a low HLB block copolymer surfactant and a high HLB block copolymer surfactant in a weight ratio ranging from about 0.5:1 to about 0.5:5; and
optionally at least one agrochemically acceptable excipient.
In a preferred embodiment, the present disclosure provides a process for preparation of the stable suspoemulsion composition, wherein the stable suspoemulsion composition comprises:
a suspension phase comprising diflubenzuron;
an emulsion phase comprising lambda-cyhalothrin; and
a crystallization controlling system comprising a low HLB block copolymer surfactant and a high HLB block copolymer surfactant in a weight ratio ranging from about 0.5:1 to about 0.5:5.

In a preferred embodiment, the present disclosure provides a process for preparation of the stable suspoemulsion composition, wherein the stable suspoemulsion composition comprises:
a suspension phase comprising diflubenzuron;
an emulsion phase comprising lambda-cyhalothrin;
a crystallization controlling system comprising a low HLB block copolymer surfactant and a high HLB block copolymer surfactant in a weight ratio ranging from about 0.5:1 to about 0.5:5; and
optionally at least one agrochemically acceptable excipient.

According to an embodiment, the present disclosure provides a process for preparation of a stable suspoemulsion composition, the process comprising:
(a) preparing a suspension phase by mixing a benzoylphenylurea insecticide in water and optionally other agrochemically acceptable excipients;
(b) preparing an emulsion phase by mixing a pyrethroid insecticide and a crystallization controlling system comprising at least two surfactants; and
(c) mixing the suspension phase and the emulsion phase to obtain the stable suspoemulsion composition.

According to an embodiment, the present disclosure provides a process for preparation of a stable suspoemulsion composition, the process comprising:
(a) preparing a suspension phase by mixing a benzoylphenylurea insecticide in water and optionally other excipients;
(b) preparing an emulsion phase by mixing a pyrethroid insecticide and a crystallization controlling system comprising a low HLB block copolymer surfactant and a high HLB block copolymer surfactant in a weight ratio ranging from about 0.5:1 to about 0.5:5; and
(c) mixing the suspension phase and the emulsion phase to obtain the stable suspoemulsion composition;
wherein the stable suspoemulsion composition comprises the suspension phase comprising the benzoylphenylurea insecticide; the emulsion phase comprising the pyrethroid insecticide; and the crystallization controlling system comprising at least two surfactants.

According to an embodiment, the present disclosure provides a process for preparation of a stable suspoemulsion composition, the process comprising:
(a) preparing a suspension phase by mixing diflubenzuron in water and optionally other excipients;
(b) preparing an emulsion phase by mixing lambda-cyhalothrin and a crystallization controlling system comprising a low HLB block copolymer surfactant and a high HLB block copolymer surfactant in a weight ratio ranging from about 0.5:1 to about 0.5:5; and
(c) mixing the suspension phase and the emulsion phase to obtain the stable suspoemulsion composition;
wherein the stable suspoemulsion composition comprises the suspension phase comprising diflubenzuron; the emulsion phase comprising lambda-cyhalothrin; and
the crystallization controlling system comprising the low HLB block copolymer surfactant and the high HLB block copolymer surfactant in a weight ratio ranging from about 0.5:1 to about 0.5:5.

According to an embodiment of the present disclosure, preparation of the emulsion phase may require high shear mixing to mix the pyrethroid insecticide and the crystallization controlling system in the solvent.

According to an embodiment of the present disclosure, preparation of the suspension phase may require milling operation to achieve desired particle size of suspended particles comprising a benzoylphenylurea insecticide.

According to an embodiment of the present disclosure, a method for controlling growth of insects/pests in plants, said method comprising applying to the insects/pests or to their locus thereof, an effective amount of the suspoemulsion composition comprising:
a suspension phase comprising a benzoylphenylurea insecticide;
an emulsion phase comprising a pyrethroid insecticide; and
a crystallization controlling system comprising at least two surfactants.

According to an embodiment of the present disclosure, a method for controlling growth of insects/pests in plants, said method comprising applying to the insects/pests or to their locus thereof, a pesticidally effective amount of the suspoemulsion composition comprising:
a suspension phase comprising a benzoylphenylurea insecticide;
an emulsion phase comprising a pyrethroid insecticide; and
a crystallization controlling system comprising at least two surfactants in a weight ratio ranging from about 0.5:1 to about 0.5:5.

According to an embodiment of the present disclosure, a method for controlling growth of insects/pests in plants, said method comprising applying to the insects/pests or to their locus thereof, a pesticidally effective amount of the suspoemulsion composition comprising:
a suspension phase comprising a benzoylphenylurea insecticide;
an emulsion phase comprising a pyrethroid insecticide; and
a crystallization controlling system comprising a low HLB block copolymer surfactant and a high HLB block copolymer surfactant in a weight ratio ranging from about 0.5:1 to about 0.5:5.

According to an embodiment of the present disclosure, a method for controlling growth of insects/pests in plants, said method comprising applying to the insects/pests or to their locus thereof, an effective amount of the suspoemulsion composition comprising:
a suspension phase comprising diflubenzuron;
an emulsion phase comprising lambda-cyhalothrin; and
a crystallization controlling system comprising a low HLB block copolymer surfactant and a high HLB block copolymer surfactant in a weight ratio ranging from about 0.5:1 to about 0.5:5.

According to an embodiment of the present disclosure, a method for controlling growth of insects/pests in plants, said method comprising applying to the insects/pests or to their locus thereof, a pesticidally effective amount of the suspoemulsion composition comprising:
a suspension phase comprising diflubenzuron;
an emulsion phase comprising lambda-cyhalothrin;
a crystallization controlling system comprising a low HLB block copolymer surfactant and a high HLB block copolymer surfactant in a weight ratio ranging from about 0.5:1 to about 0.5:5; and
optionally at least one agrochemically acceptable excipient.

According to an embodiment of the present disclosure, a method for controlling growth of insects/pests in plants, said method comprising applying to the insects/pests or to their locus thereof, an pesticidally effective amount of the suspoemulsion composition comprising:
a suspension phase comprising diflubenzuron;
an emulsion phase comprising lambda-cyhalothrin; and
a crystallization controlling system comprising block copolymers of polyethylene glycol and polyhydroxystearic acid; and block copolymeric surfactants in a weight ratio ranging from about 0.5:1 to about 0.5:5.

According to an embodiment of the present disclosure, a method for controlling growth of insects/pests in plants, said method comprising applying to the insects/pests or to their locus thereof, a pesticidally effective amount of the suspoemulsion composition comprising:
a suspension phase comprising diflubenzuron;
an emulsion phase comprising lambda-cyhalothrin; and
a crystallization controlling system comprising block copolymers of polyethylene glycol and polyhydroxystearic acid; and block copolymeric surfactants in a weight ratio of about 0.5:1.

According to an embodiment of the present disclosure, a method for controlling growth of insects/pests in plants, said method comprising applying to the insects/pests or to their locus thereof, a pesticidally effective amount of the suspoemulsion composition comprising:
a suspension phase comprising diflubenzuron;
an emulsion phase comprising lambda-cyhalothrin; and
a crystallization controlling system comprising block copolymers of polyethylene glycol and polyhydroxystearic acid; and block copolymeric surfactant in a weight ratio of about 0.5:2.

According to an embodiment of the present disclosure, a method for controlling insects/pests in plants, said method comprising applying to the insects/pests or to their locus thereof, a pesticidally effective amount of the suspoemulsion composition comprising:
a suspension phase comprising diflubenzuron;
an emulsion phase comprising lambda-cyhalothrin; and
a crystallization controlling system comprising block copolymers of polyethylene glycol and polyhydroxystearic acid; and block copolymeric surfactant in a weight ratio of about 1:1.

According to an embodiment of the present disclosure, a method for controlling insects/pests in plants, said method comprising applying to the insects/pests or to their locus thereof, a pesticidally effective amount of the suspoemulsion composition comprising:
a suspension phase comprising diflubenzuron;
an emulsion phase comprising lambda-cyhalothrin; and
a crystallization controlling system comprising block copolymers (A-B-A) of polyethylene glycol and polyhydroxystearic acid; and block copolymeric surfactant in a weight ratio of about 2:1.

According to an embodiment of the present disclosure, a method for controlling insects/pests in plants, said method comprising applying to the insects/pests or to their locus thereof, a pesticidally effective amount of the suspoemulsion composition comprising:
a suspension phase comprising diflubenzuron;
an emulsion phase comprising lambda-cyhalothrin; and
a crystallization controlling system comprising block copolymers of polyethylene glycol and polyhydroxystearic acid; and block copolymeric surfactant in a weight ratio of about 1:2.

According to an embodiment, the present disclosure provides a method for controlling insects/pests in plants, wherein the suspoemulsion composition is applied in a range from about 10 g a.i./ha to about 5000 g a.i./ha.

In a preferred embodiment, the present disclosure provides a method for controlling insects/pests in plants, wherein the suspoemulsion composition is applied in a range from about 10 g a.i./ha to about 3000 g a.i./ha.

In a preferred embodiment, the present disclosure provides a method for controlling insects/pests in plants, wherein the suspoemulsion composition is applied in a range from about 10 g a.i./ha to about 1500 g a.i./ha.

In a preferred embodiment, the present disclosure provides a method for controlling insects/pests in plants, wherein the suspoemulsion composition is applied in a range from about 10 g a.i./ha to about 500 g a.i./ha.

In a preferred embodiment, the present disclosure provides a method for controlling insects/pests in plants, wherein the suspoemulsion composition is applied in a range from about 50 g a.i./ha to about 450 g a.i./ha.

In a preferred embodiment, the present disclosure provides a method for controlling insects/pests in plants, wherein the suspoemulsion composition is applied in a range from about 100 g a.i./ha to about 400 g a.i./ha.

According to an embodiment, the insect pest may be from Lepidopteran, Coleopteran, Hemipteran, or Homopteran species. However, the choice of the target insect pests is not limiting.

In an embodiment, Lepidopteran pest species which negatively impact agriculture include, but are not limited to, Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvet bean caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp. (noctuid moths), Pseudaletia unipunctata (armyworm), Pseudoplusia includens (soybean looper), Rachiplusia nu, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera frugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer) and Zeuzera pyrina (leopard moth).

In yet another embodiment, the insect pests are of the order Orthoptera, such as Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), chistocerca gregaria, Scudderia furcata (forktailed bush katydid) and Valanga nigricorni.

In yet another embodiment, the insect pests are of the order Thysanoptera, such as Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis and Thrips spp.

In an embodiment Coleopteran insect pests may be selected from but not limited to Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf Ceutorhynchus beetle), spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils). Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpoean chafer), Rhynchophorus spp. (weevils). Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

In an embodiment, the insect pests are of the order Hemiptera, such as Acrosternum hilare (green stink bug), Blissus leucopterus (chinch bug), Calocoris norvegicus (potato mind), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea and Triatoma spp. (bloodsucking conenose bugs/kissing bugs).

In an embodiment, the insect pests are of the order Homoptera, such as Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweet potato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red bawax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale) and Zulia entreriana.

According to an embodiment, the target crop may include, cereals such as wheat, barley, rye, oats, corn, rice, sorghum, triticale and related crops; beets such as sugar beet and fodder beet; leguminous plants such as beans, lentils, peas, soybean, chickpeas; dry bean, dry pea, rye, triticale, oat, wheat, barley, oil plants such as rape, mustard, sunflowers; cucurbits such as marrows, cucumbers, melons; fibre plants such as cotton, flax, hemp, jute; vegetables such spinach, lettuce, asparagus, cabbages, carrots, onions, tomatoes, potatoes, paprika as well as ornamentals such as flowers, shrubs, broad-leaved trees and evergreens, such as conifers.

According to an embodiment, the target crop may be selected from soybean, orange, raspberries, broccoli, prune, corn, peach, mango, celery, conifer, tangerine, kiwifruit, gooseberry, plum, pumpkin, beet, starfruit, bean, carrot, asparagus, apple, crab-apple, Swiss chard, and many more.

According to an embodiment of the present disclosure, the various components of the suspoemulsion composition can be used individually or already partially or completely mixed with one and at least one other to prepare the composition according to the disclosure. It is also possible for them to be packaged and used further as composition such as a kit of parts.

The disclosure also provides a kit comprising suspoemulsion composition for the controlling growth of insects/pests and instructions for use. The instructions for use typically comprise instructions for the application of the suspoemulsion composition to the pest or to their locus thereof.

According to an embodiment, the kit of parts comprises:
a suspension phase comprising a benzoylphenylurea insecticide;
an emulsion phase comprising a pyrethroid insecticide;
a crystallization controlling system;
and optionally further comprises:

instructions for use.

In one embodiment of the disclosure, the kit may include one or more, including all, components that may be used to prepare the suspoemulsion composition, e.g., kits may include active ingredients and/or agrochemically acceptable excipient. One or more of the components may already be combined together or pre-formulated. In those embodiments where more than two components are provided in a kit, the components may already be combined together and as such are packaged in a single container such as a vial, bottle, can, pouch, bag or canister. In other embodiments, two or more components of a kit may be packaged separately, i.e., not pre-formulated. As such, kits may include one or more separate containers such as vials, cans, bottles, pouches, bags or canisters, each container containing a separate component for suspoemulsion composition.

In both forms, a component of the kit may be applied separately from or together with the further components or as a component of a composition according to the disclosure for preparing the suspoemulsion composition according to the disclosure.

In another embodiment, the suspoemulsion composition described above is stable, over time and at various temperatures.

In another embodiment, the suspoemulsion composition of the present disclosure has improved shelf life.

In another embodiment, the suspoemulsion composition of the present disclosure prevents crystal growth in the composition upon storage.

While the disclosure will now be described in connection with certain preferred embodiments in the following examples, it will be understood that it is not intended to limit the disclosure to these particular embodiments. On the contrary, it is intended to cover all alternatives, modifications and equivalents as may be included within the scope of the disclosure as defined by the appended claims. Thus, the following examples, which include preferred embodiments, will serve to illustrate the practice of this disclosure, it being understood that the particulars shown are by way of example and for purposes of illustrative discussion of preferred embodiments of the present disclosure only and are presented in the cause of providing what is believed to be the most useful and readily understood description of procedures as well as of the principles and conceptual aspects of the disclosure.

### EXAMPLES

### Example 1: Preparation of Lambda-Cyhalothrin 11% w/w+Diflubenzuron 22% w/w Suspoemulsion (SE)

| | |
|---|---|
| Ingredients | Quantity (% w/w) |

Emulsion Phase

| Lambda-cyhalothrin | | 11.00 |
|---|---|---|
| Solvent | | 9.50 |
| Crystallization | Block copolymer of polyethylene | 0.50 |
| controlling | glycol and polyhydroxystearic acid | |
| system | Polyalkylene glycol ether; | 2.00 |
| | Polyalkylene oxide block copolymer | |

| | |
|---|---|
| Phosphoric acid 85% | 0.05 |
| Water | Q.S. |

Suspension Phase

| | |
|---|---|
| Diflubenzuron | 22.00 |
| Dispersing agent | 2.4 |
| Propylene glycol | 3.00 |
| Water | Q.S. |
| Total | 100 |

### Process:

The suspoemulsion was prepared as follows:

### A. Preparation of Emulsion Phase:

Vessel-1 was maintained under 50-60° C. and to the vessel-1, 9.5 g solvent and 11 g lambda-cyhalothrin was added and mixed. Then 0.5 g block copolymer of polyethylene glycol and polyhydroxystearic acid, and 2 g polyalkylene glycol ether; polyalkylene oxide block copolymer was added under high shear to obtain a clear solution. The solution was allowed to cool to room temperature. Then phosphoric acid along with other agrochemically acceptable excipients was added under stirring to obtain an emulsion phase.

### B. Preparation of Suspension Phase:

2.4 g dispersing agent and 3 g propylene glycol were added with water in vessel-1 and mixed in vessel-2 to obtain a homogeneous mixture. Then 22 g diflubenzuron was charged in the same vessel-2 under continuous stirring to obtain a slurry. To the slurry, other agrochemically acceptable excipients was added. Finally, pH of the suspension phase was adjusted with phosphoric acid to obtain a suspension phase.

### C. Preparation of the Suspoemulsion Composition:

Vessel-2 with the suspension phase was kept under low shear and slowly, the emulsion phase of vessel-1 was added and mixed thoroughly to obtain the suspoemulsion composition.

### Example 2: Physico-Chemical Study of the Suspoemulsion

The composition of Example-1 was tested for physico-chemical stability of the suspoemulsion. The suspoemulsion appeared as beige colour homogeneous liquid. The active content of diflubenzuron was maintained at 22% w/w and active content of lambda-cyhalothrin was maintained at 11% w/w. Dispersion stability was tested by mixing 2% suspoemulsion in water and kept for 30 minutes. 0.1% sediment and 0.1% cream was observed which was within the acceptable limit. Viscosity of the composition of Example-1 was found to be within 150-350 cps.

Composition of Example-1 was tested for Accelerated Heat Stability (AHS), wherein the sample was kept at 54° C. for 2 weeks and at 40° C. for 8 weeks. Active content of both diflubenzuron and lambda-cyhalothrin was found to be within the acceptable limit, when tested at 2 weeks and at 8 weeks. Composition of Example-1 showed excellent dispersion stability with lesser than 0.05% sediment and no creaming. Viscosity of the composition was found to be 242 cps after 2 weeks and 243 cps after 8 weeks respectively. Therefore, it was concluded that the composition of Example-1 remained quite stable in ambient as well as AHS conditions, which assured overall stability of the composition up to 2 years, As disclosed in Table 1.

TABLE 1
Physico-chemical stability study

| | 0 days | 2 weeks/ | 8 weeks/ | 1 year |
|---|---|---|---|---|
| Property | (Ambient) | 54° C. | 40° C. | (Ambient) |
| Color and | Beige | Beige colour | Beige colour | Beige colour |
| appearance | colour | liquid with | liquid with | liquid with |
| | liquid | layer of top | trace of top | trace of top |
| | | separation; | separation; | separation; |
| | | Reconstituted | Reconstituted | Reconstituted |
| | | within 10 | within 10 | within 10 |
| | | inversions | inversions | inversions |
| Diflubenzuron | 21.8 | 21.8 | 22.1 | 22.1 |
| Assay, w/w % | | | | |
| Lambda- | 11.1 | 11.1 | 11.1 | 11.1 |
| cyhalothrin | | | | |
| Assay, w/w % | | | | |
| Dispersion | <0.05 | <0.05 | <0.05 | <0.05 |
| stability 2% in | sediment | sediment | sediment | sediment |
| water in 30 | No cream | No cream | No cream | No cream |
| minutes (%) | visible | visible | visible | visible |
| Viscosity @ | 313 | 242 | 243 | 301 |
| 20° C. (spindle | | | | |
| #2, 60 rpm, | | | | |
| 120 secs, cps | | | | |

### Example 3: Particle Size Analysis

The composition of Example-1 was analysed for particle size of the dispersed phase in various testing conditions such as ambient, low temperature at 0° C., AHS at 40° C. and at 54° C. It was found that the particle size of the composition of Example-1 remained quite stable in all the testing conditions. Under ambient conditions, particle size (D50) was found to be 1.867 μm and remained almost constant without significant deviation at 0° C., 40° C. and 54° C. Similarly, (D90) was found to be 5.923 μm and remained almost constant without significant deviation at 0° C., 40° C. and 54° C., as disclosed in Table 2.

TABLE 2
Particle size analysis

Particle size

| Testing condition | D₅₀ | D₉₀ |
|---|---|---|
| Ambient | 1.867 | 5.923 |
| 0° C. | 1.862 | 5.172 |
| At 40° C.; 8 weeks | 2.095 | 8.162 |
| At 54° C.; 2 weeks | 2.331 | 9.760 |

### Example 4: Microscopy Analysis to Understand Role of Crystallization Controlling System

To understand the effect of block copolymer of polyethylene glycol and polyhydroxystearic acid; and polyalkylene glycol ether and polyalkylene oxide block copolymer, on the crystal growth of the compositions, following compositions were developed:
Composition of Example-2: Without block copolymer of polyethylene glycol and polyhydroxystearic acid; and
Composition of Example-3: Without polyalkylene glycol ether and polyalkylene oxide block copolymer
Ambient condition, 2 weeks: Crystal growth was not observed for the composition of Example-1. Crystal growth was not too significant for compositions of Examples 2 and 3, but flocculation was observed.
At 0° C., 2 weeks: Crystal growth was not observed in all the 3 compositions of Examples 1-3, but flocculation was observed in the composition of Example-2 and Example-3.
At 40° C., 8 weeks: Flocculation was observed in the compositions of Example-1 and Example-2 within acceptable limits, but crystals were observed in the composition of Example-3.
At 54° C. 2 weeks: Both the compositions of Example-2 and Example-3 showed crystal growth, whereas composition of Example-1 remained as before without any crystal growth. This has been disclosed in Tables 3 and 4.

TABLE 3
Crystallization analysis for crystal growth

| | Quantity (% w/w) | | |
|---|---|---|---|
| | | Example-2 | Example-3 |
| | | (Comparative | (Comparative |
| Ingredients | Example-1 | Example) | Example) |

Emulsion Phase

| | | | |
|---|---|---|---|
| Lambda-cyhalothrin | 11.00 | 11.00 | 11.00 |
| Solvent | 9.50 | 9.50 | 9.50 |
| Block copolymer of | 0.50 | — | 0.50 |
| polyethylene glycol and | | | |
| polyhydroxystearic acid | | | |
| Polyalkylene glycol ether; | 2.00 | 2.00 | — |
| Polyalkylene oxide block | | | |
| copolymer | | | |
| Phosphoric acid 85% | 0.05 | 0.05 | 0.05 |
| Water | Q.S. | Q.S | Q.S |

Suspension Phase

| | | | |
|---|---|---|---|
| Diflubenzuron | 22.00 | 22.00 | 22.00 |
| Dispersing agent | 2.4 | 2.4 | 2.4 |
| Propylene glycol | 3.00 | 3.00 | 3.00 |
| Water | Q.S. | Q.S. | Q.S. |

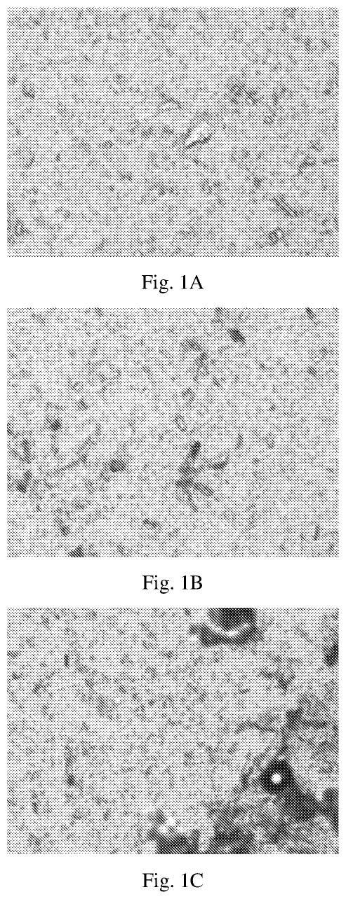

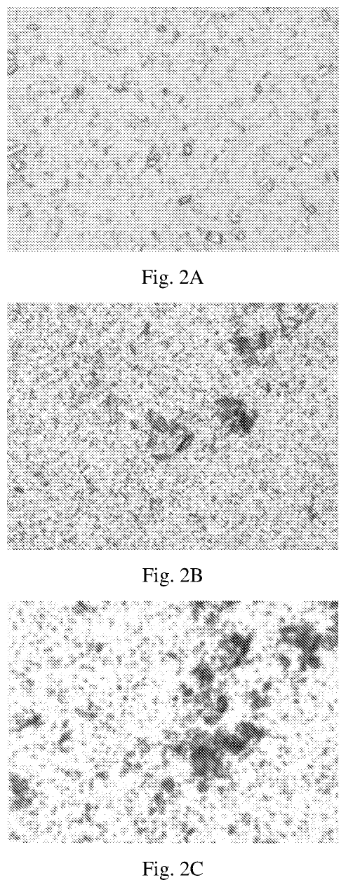

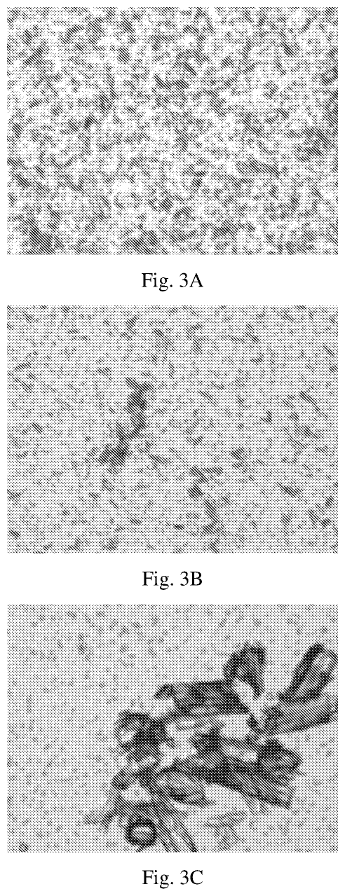

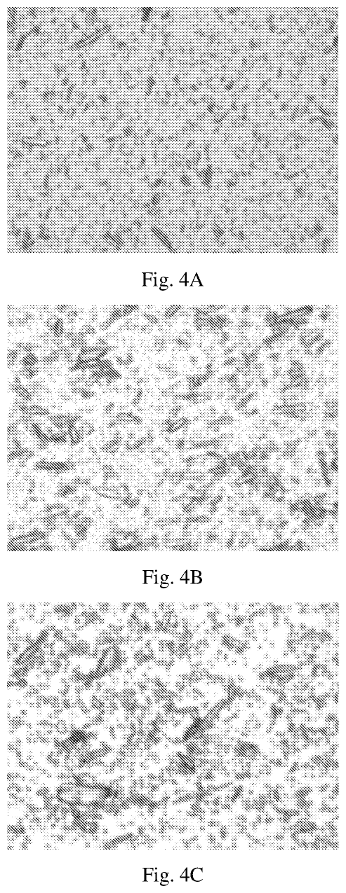

TABLE 4
Crystallization analysis for crystal growth

| Parameters | Example-1 | Example-2 | Example-3 |
|---|---|---|---|
| 0° C., 2 weeks | FIG. 1A | FIG. 1B | FIG. 1C |
| Ambient, 2 weeks | FIG. 2A | FIG. 2B | FIG. 2C |
| 40° C., 2 weeks | FIG. 3A | FIG. 3B | FIG. 3C |
| 54° C., 2 weeks | FIG. 4A | FIG. 4B | FIG. 4C |

Therefore, inventors of the present disclosure successfully resolved the crystal growth issues associated with suspoemulsion compositions of a pyrethroid insecticide and a benzoylphenylurea insecticide. The presence of crystallization controlling system comprising a low HLB block copolymer surfactant and a high HLB block copolymer surfactant in a weight ratio ranging from about 0.5:1 to about 0.5:5 in the emulsion phase of the suspoemulsion composition was found to tackle crystal growth issues associate with the benzoylphenylurea insecticide, which is present as suspended particles in the suspoemulsion composition and provided stabilizing effect to the composition of the present disclosure.

### Example 5: Preparation of Lambda-Cyhalothrin 11% w/w+Diflubenzuron 22% w/w Suspoemulsion (SE)

| Ingredients | Quantity (% w/w) |
|---|---|
| Diflubenzuron | 22.0 |
| Lambda Cyhalothrin | 11.0 |
| Polyalkylene glycol ether; Polyalkylene oxide block | 2.0 |
| copolymer | |
| Polyoxyethylene polyoxypropylene block co-polymer | 1.4 |
| Solvent | 9.5 |
| Dispersing agent | 1.0 |
| Phosphoric acid 85% | 0.25 |
| Water | Q.S. |
| Total | 100 |

### Process

The suspoemulsion was prepared as follows:

### A. Preparation of Emulsion Phase:

Vessel-1 was maintained under 50-60° C. and to the vessel-1, 9.5 g solvent and 11 g lambda-cyhalothrin was added and mixed. Then 2.0 g of polyalkylene glycol ether; polyalkylene oxide block copolymer was added under high shear to obtain a clear solution. The solution was allowed to cool to room temperature. Then phosphoric acid was added under stirring to obtain an emulsion phase.

### B. Preparation of Suspension Phase:

22 g diflubenzuron along with other agrochemically acceptable excipients was charged in vessel-2 under continuous stirring to obtain a slurry. The pH of the suspension phase was adjusted with phosphoric acid to obtain a suspension phase.

### C. Preparation of the Suspoemulsion Composition:

Vessel-2 with the suspension phase was kept under low shear and slowly, the emulsion phase of vessel-1 was added and mixed thoroughly to obtain the suspoemulsion composition.

What is claimed is:

1. A suspoemulsion composition comprising:
a suspension phase comprising a benzoylphenylurea insecticide;
an emulsion phase comprising a pyrethroid insecticide; and
a crystallization controlling system comprising at least two surfactants.

2. The composition as claimed in claim 1, wherein the benzoylphenylurea insecticide is selected from the group consisting of diflubenzuron, chlorbenzuron, chlorfluazuron, dichlorbenzuron, flufenoxuron, hexaflumuron, lufenuron, novaluron, noviflumuron, penfluron, teflubenzuron, triflumuron, and combinations thereof.

3. The composition as claimed in claim 1, wherein the composition comprises from about 0.1% w/w to about 60% w/w of the benzoylphenylurea insecticide based on a total weight of the composition.

4. The composition as claimed in claim 1, wherein the pyrethroid insecticide is selected from the group consisting of lambda-cyhalothrin, bifenthrin, cypermethrin, gamma-cyhalothrin, deltamethrin, transfluthrin, permethrin, cyhalothrin, and combinations thereof.

5. The composition as claimed in claim 1, wherein the composition comprises from about 0.1% w/w to about 60% w/w of the pyrethroid insecticide based on a total weight of the composition.

6. The composition as claimed in claim 1, wherein the crystallization controlling system comprising at least two surfactants is selected from a low hydrophile-lipophile balance (HLB) block copolymer surfactant and a high HLB block copolymer surfactant.

7. The composition as claimed in claim 6, wherein the crystallization controlling system comprises a low HLB block copolymer surfactant and a high HLB block copolymer surfactant in a weight ratio ranging from about 0.5:1 to about 0.5:5.

8. The composition as claimed in claim 6, wherein the low HLB block copolymer surfactant is selected from the group consisting of block copolymers of polyethylene glycol and polyhydroxystearic acid, random copolymer of poly alkyl resin with polyethylene glycol and polymeric ester, polyoxyethylene polyoxypropylene block copolymer, and combinations thereof.

9. The composition as claimed in claim 6, wherein the high HLB block copolymer surfactant is selected from the group consisting of hydrophilic methyl methacrylate graft copolymer and block copolymeric alkoxylates made by polyalkylene glycol ether and polyalkylene oxide block copolymer, and combinations thereof.

10. The composition as claimed in claim 6, wherein the composition comprises from about 0.01% w/w to about 10% w/w low HLB block copolymer surfactant, and from about 0.01% w/w to about 10% w/w high HLB block copolymer surfactant of total weight of the crystallization controlling system.

11. The composition as claimed in claim 1, wherein the composition comprises from about 0.1% w/w to about 60% w/w of the benzoylphenylurea insecticide; from about 0.1% w/w to about 60% w/w of the pyrethroid insecticide; and from about 0.01% w/w to about 10% w/w of the crystallization controlling system based on a total weight of the composition.

12. The composition as claimed in claim 1, wherein the composition comprises a particle size distribution as D50 ranging from about 1.0 μm to about 3.0 μm and D90 ranging from about 4.0 μm to about 10.0 μm.

13. A suspoemulsion composition comprising:
a suspension phase comprising diflubenzuron;
an emulsion phase comprising lambda-cyhalothrin;
a crystallization controlling system comprising a low HLB block copolymer surfactant and a high HLB block copolymer surfactant in a weight ratio ranging from about 0.5:1 to about 0.5:5; and
at least one agrochemically acceptable excipient.

14. The composition as claimed in claim 13, wherein the agrochemically acceptable excipients are selected from the group consisting of surfactant(s)/dispersing agent(s), antifreeze agent(s), wetting agent(s), antifoaming agent(s), emulsifier(s)/thickener(s), preservative(s), colorant(s), filler(s), antioxidant(s), solvent(s), and combinations thereof.

15. The composition as claimed in claim 13, wherein the composition comprises from about 0.1% w/w to about 60% w/w of the diflubenzuron; from about 0.1% w/w to about 60% w/w of the lambda-cyhalothrin; from about 0.01% w/w to about 10% w/w of the crystallization controlling system; and from about 1% w/w to about 30% w/w of the at least one agrochemically acceptable excipient of based on a total weight of the composition.

16. Use of a suspoemulsion composition comprising a suspension phase comprising a benzoylphenylurea insecticide; an emulsion phase comprising a pyrethroid insecticide; and a crystallization controlling system comprising at least two surfactants, for controlling growth of insects/pests in plants.

17. A process for preparing a suspoemulsion composition, the process comprising:
(a) preparing a suspension phase by mixing a benzoylphenylurea insecticide in water and optionally at least one agrochemically acceptable excipient;
(b) preparing an emulsion phase by mixing a pyrethroid insecticide and a crystallization controlling system comprising at least two surfactants; and
(c) mixing the suspension phase and the emulsion phase to obtain the suspoemulsion composition.

18. The process as claimed in claim 17, wherein the at least two surfactants comprise a low HLB block copolymer surfactant and a high HLB block copolymer surfactant.

19. The process as claimed in claim 18, wherein low HLB block copolymer surfactant and the high HLB block copolymer surfactant are at a weight ratio ranging from about 0.5:1 to about 0.5:5.

20. A method for controlling growth of insects/pests, comprising applying to the insects/pests or to their locus thereof, an effective amount of a suspoemulsion composition comprising a suspension phase comprising a benzoylphenylurea insecticide; an emulsion phase comprising a pyrethroid insecticide; and a crystallization controlling system comprising at least two surfactants.

21. The method as claimed in claim 20, wherein the at least two surfactants comprise a low HLB block copolymer surfactant and a high HLB block copolymer surfactant in a weight ratio ranging from about 0.5:1 to about 0.5:5.
